(19) United States
(12) Patent Application Publication
(10) Pub. No.: US 2012/0184126 A1
(43) Pub. Date: Jul. 19, 2012

(54) CABLE CONNECTOR ASSEMBLY WITH IMPROVED COVER

(75) Inventors: Chiao Chen, New Taipei (TW); Xian-Bao Su, Kunshan (CN); Li-Hua Zhu, Kunshan (CN)

(73) Assignee: HON HAI PRECISION INDUSTRY CO., LTD., New Taipei (TW)

(21) Appl. No.: 13/349,575

(22) Filed: Jan. 13, 2012

(30) Foreign Application Priority Data
Jan. 14, 2011 (CN) 201120012084.2

(51) Int. Cl. H01R 13/639; H01R 13/04

(52) U.S. Cl. 439/345; 439/694

(57) ABSTRACT

A cable connector assembly (100) comprises an insulative housing (1), a printed circuit board (2) received in the insulative housing, a cable (3) electrically connected with the printed circuit board and an insulative cover (4) assembled to the insulative housing. The insulative housing has a body portion (10) with a receiving slot (101) and a pair of tongue sections (110, 111) opposite to each other and respectively extending forwardly from a front surface of the body portion. The printed circuit board is extending along a mating direction, and the cable is extending along a direction perpendicular to the mating direction, the cover is over-molded on the cable and the printed circuit board, and engaging with the insulative housing.

### BACKGROUND OF THE INVENTION

1. Field of the Invention

The present invention generally relates to a cable connector assembly, and more particularly to a cable connector assembly used for high-speed signal transmission.

2. Description of Related Art

A committee called SFF is an ad hoc group formed to address storage industry needs in a prompt manner. When formed in 1990, the original goals were limited to define de facto mechanical envelopes within disk drives can be developed to fit compact computer and other small products. Specification SFF-8087 defines physical interface and general performance requirements of the mating interface for a Compact Multilane Connector which is designed for using in high speed serial interconnect applications at speeds up to 10 Gigabits/second. The Compact Multilane Connector defined in the SFF-8087 comprises a printed circuit board, a plurality of high-speed cables and low-speed wires respectively electrically connected with the printed circuit board to form a plurality of junctions therebetween, a PVC housing overmolding to the printed circuit board and the cables. The PVC housing comprises a rectangular body portion enclosing the junctions and a pair of tongue portions respectively extending forwardly from the body portion. The front portion of the printed circuit board is exposed between the pair of tongue portions for electrically connecting with a complementary connector. The Compact Multilane Connector also comprises a latch member assembled to a top surface of the body portion of the housing for latching with the complementary connector.

As the trend of miniaturization, the inner space of the electronic equipment becomes more and more small, and traditional cable connector assembly may occupy relatively big space in the electronic equipment.

CN patent No. 201178151Y issued to Liu on Jan. 7, 2009 discloses a cable connector assembly, the cable connector assembly comprises an insulative housing, a printed circuit board received in the insulative housing and a cable electrically connected with the printed circuit board. The insulative housing includes a top cover and a bottom cover assembled with each other, the cable is extending out from a lateral side of the insulative housing. However the cost of pre-forming the top cover and the bottom cover is higher, and it's difficult for assembling the top cover to the bottom cover, and a latch engaging therebetween may be broken easily.

Hence, it is desirable to have an improved structure to overcome the above-mentioned disadvantages of the prior art.

### BRIEF SUMMARY OF THE INVENTION

Accordingly, the object of the present invention is to provide a cable connector assembly with an improved insulative cover.

In order to achieve the above-mentioned object, a cable connector assembly in accordance with the present invention comprises an insulative housing, a printed circuit board received in the insulative housing, a cable electrically connected with the printed circuit board and an insulative cover assembled to the insulative housing. The insulative housing has a body portion with a receiving slot and a pair of tongue sections opposite to each other and respectively extending forwardly from a front surface of the body portion. The printed circuit board is extending along a mating direction, and the cable is extending along a direction perpendicular to the mating direction, the cover is over-molded on the cable and the printed circuit board, and engaging with the insulative housing.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is an assembled, perspective view of a cable connector assembly in accordance with the present invention;

FIG. 2 is a view similar to FIG. 1, but viewed from a different angle;

FIG. 3 is an exploded, perspective view of the cable connector assembly shown in FIG. 1; and

FIG. 4 is a view similar to FIG. 3, but viewed from another aspect.

### DETAILED DESCRIPTION OF THE INVENTION

Reference will now be made to the drawing figures to describe the present invention in detail.

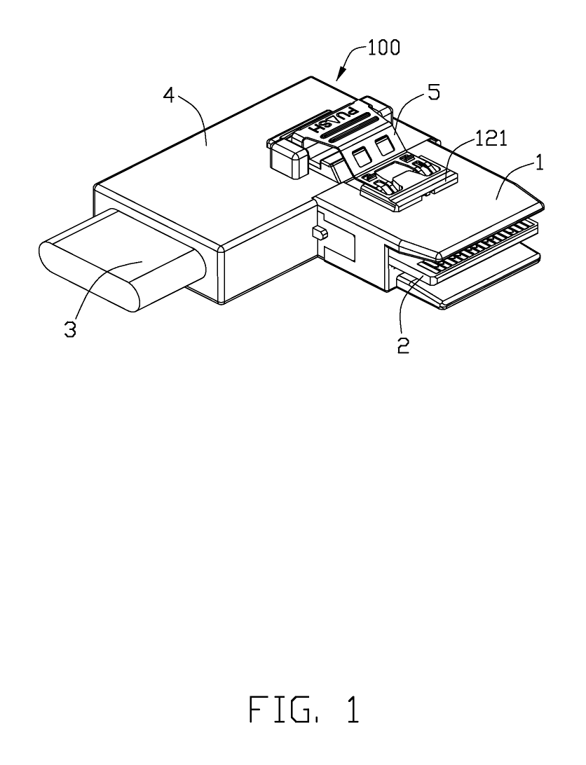

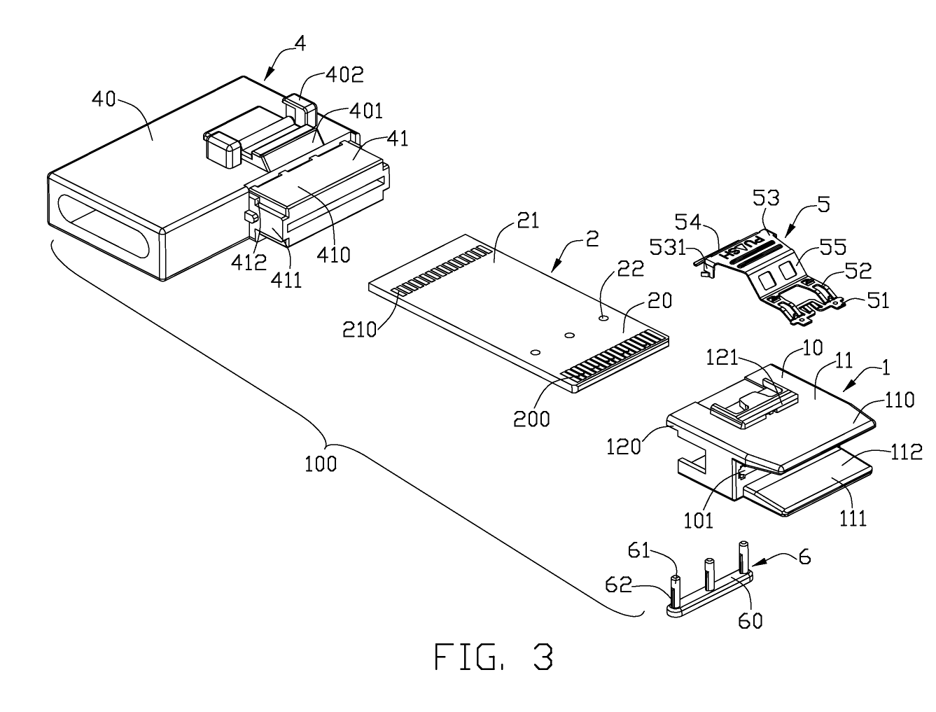

Referring to FIGS. 1-3, a cable connector assembly 100 made in accordance with the present invention comprises an insualtive housing 1 defining a mating direction, a printed circuit board 2 assembled to the insulative housing 1, a cable 3 electrically connected to the printed circuit board 2, an insulative cover 4 molded on a back end of the printed circuit board 2 and a front end of the cable 3, a pin member 6 assembled to the insulative housing 1 for holding the printed circuit board 2 with the insulative housing reliably, and a resilient latch member 5 assembled to the insulative housing 1 and the insulative cover 4 for attaching the cable connector assembly 100 with a complementary connector (not shown).

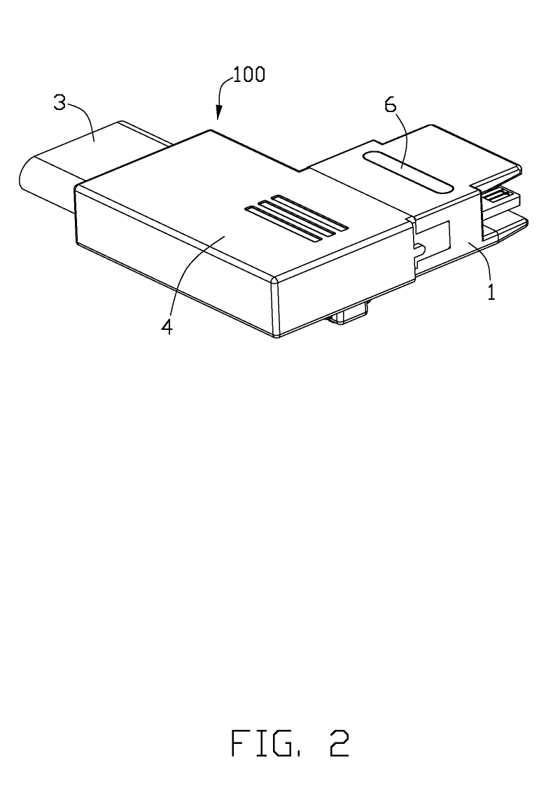

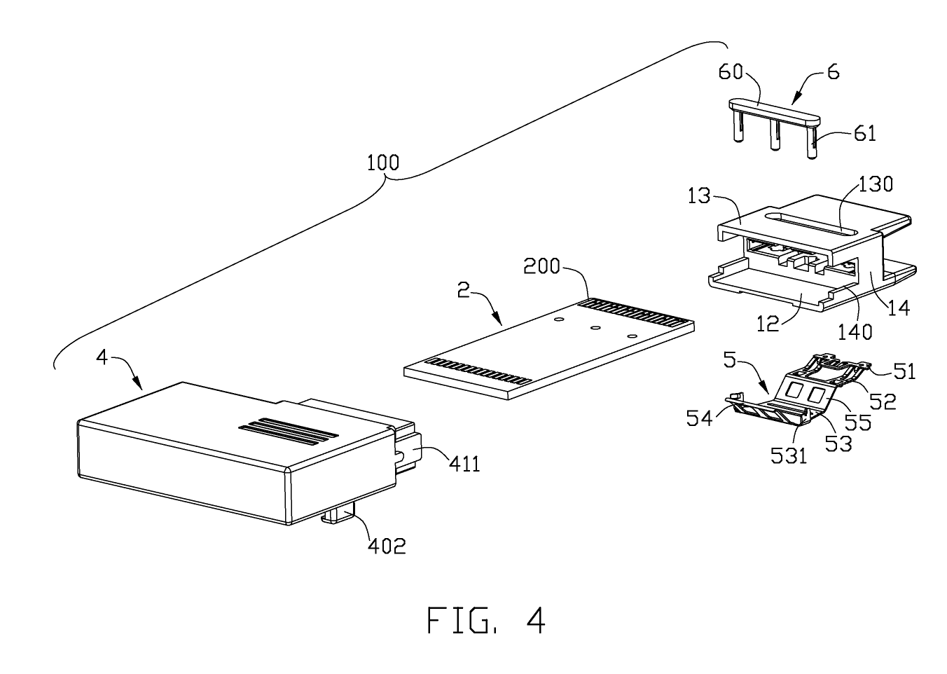

Referring to FIGS. 2-4, the insulative housing 1 is made of insulative material with enough rigidity, and comprises a rectangular body portion 10 defining a central receiving slot 101 therethrough, and a pair of tongue sections 110, 111 opposite to each other and respectively extending forwardly from a front surface of the body portion 10. The tongue sections 110, 111, together with an opening 112 defined between the pair of tongue sections 110, 111, form a mating interface 11 of the insulative housing 1.

The body portion 10 comprises an upper wall 12, a lower wall 13 opposite to the upper wall 12, and a pair of lateral walls 14 connected to the upper and lower walls 12, 13. These walls 12, 13 and 14 together define a receiving space (not labeled) recessed a predetermined distance to communicate with the receiving slot 101. Each lateral wall 14 defines a cutout 140 to communicate with the receiving space. In addition, the upper wall 12 extends rearwardly beyond the lower wall 13 a predetermined distance along the mating direction and forms a step portion 120. The lower wall 13 defines a depressed opening 130 depressed a predetermined distance from a surface thereof, and the depressed opening 130 is not extending through the lower wall 13. The depressed opening 130 defines triple holes (not shown) extending through the lower wall 13 and communicated with the receiving slot 101. An M-shaped mounting portion 121 is defined on the upper wall 12 of the body portion 10.

The printed circuit board 2 forms a plurality of first conductive pads 200 at a mating portion 20 thereof and a plurality of second conductive pads 210 at a rear portion 21 thereof. The conductive pads 200, 210 are arranged on opposite upper and lower surfaces of the printed circuit board 2. Triple circular through holes 22 are disposed between the first and second conductive pads 200, 210, and the through holes 22 are arranged along a transverse direction perpendicular to the mating direction, the through holes 22 are aligned with the corresponding holes in the depressed opening 130 of the insulative housing 1. To realize hot plug function, the first conductive pads 200, which are used for signal transmission, are formed with V-shaped cutouts (not labeled) to let the first conductive pads 200, which are used for grounding, to mate with the complementary connector firstly and break from the complementary connector lastly. Such V-shaped cutout structure assures the signal transmission without dimple. Of course, the V-shaped cutout also can be omitted here or have other configurations.

The cable 3 of the present invention is flat, and a horizontal central plane of the cable is coplanar to a center surface of the insulative housing 1 and the insulative cover 4.

The cover 4 is made of insulative material, and soft than the insulative housing 1. In other embodiments, the cover 4 also can be made from the material same as that of the insulative housing 1. The cover 4 comprises a main portion 40 and a projecting portion 41 forwardly extending from a front surface of the main portion 40. The main portion 40 is extending along the transverse direction, and the projecting portion 41 is neighboring to one side of the projecting portion 41 and extending along the mating direction, thus the main portion 40 and the projecting portion 41 form an L-shaped configuration. The main portion 40 defines a protrusion 401 extending upwards from a top surface thereof and a pair of ear portions 402 on both sides of the protrusion 401. Each ear portion 402 has a height greater than that of the protrusion 401. The projecting portion 41 defines a rectangular primary portion 410 and a pair of engaging portions 411 on both sides of the primary portion 410, the engaging portions 411 are extending outwards respectively. The engaging portions 411 are received in the cutout 140 of the insulative housing 1, and each engaging portion 411 has a step-shaped stopping portion 412 abutting against the step portion 120.

The latch member 5 is stamped and formed from a metallic plate and comprises a retaining portion 51, a pair of locking portions 52 extending upwardly and rearwardly from the retaining portion 51, a n-shaped pressing portion 53 formed at a rear position of the pair of locking portions 52, and an inclined supporting portion 54 slantwise extending from the pressing portion 53. The locking member 5 further defines an inclined intermediate portion 55 connecting the pressing portion 53 with the locking portions 52. The pressing portion 53 defines a pair of spring tab 531 disposed at two sides thereof.

The pin member 6 comprises a longitudinal strip 60 that can be received in the depressed opening 130, and triple columned pins 61 extending from the strip 60 with a diameter generally equal to that of the holes of the insulative housing 1 and the through holes 22 of the printed circuit board 2 such that the pins 61 can extend through said holes. Each pin 61 further comprises at least one rib 62 thereon for providing an interference fit with the holes and holding the printed circuit board 2 with the insulative housing 1 reliably.

In assembly, wires of the cable 3 are divided into two rows soldered to the second conductive pads 210 located on the upper and lower surfaces of the printed circuit board 2, an insulator (not shown) is molded on an electrical conjunction between the cable 3 and the printed circuit board 2. The printed circuit board 2 is extending along the mating direction, the cable 3 is extending along the direction perpendicular to the mating direction, and that is to say, the cable 3 is located vertical to the printed circuit board 2. Then the cover 4 is over-molded on the insulator, the cable 3 and the printed circuit board 2 partially. The cable 3 is extending along the direction same as that of the main portion 40 of the cover 4.

Then the cover 4 is assembled to the insulative housing 1 along the mating direction, the engaging portions 411 of the cover 4 slide into the cutouts 140 of the insulative housing 1, the mating portion 20 of the printed circuit board 2 protrudes through the receiving slot 101 of the insulative housing 1 to be exposed between the first and second tongue sections 110, 111 until the step portions 120 of the insulative housing 1 fitly mates with the stopping portions 412 of the cover 4. Thus, the projecting portion 41 of the cover 4 is received in the receiving space formed by the walls 12, 13 and 14 of the insulative housing 1. In particular, the through holes 22 of the printed circuit board 2 respectively align with the holes in the depressed opening 130 of the insulative housing 1.

Then the pin member 6 is inserted into the depressed opening 130 of the insulative housing 1 along a down-to-up direction, the strip 60 of the pin member 6 is received in and substantially covers the depressed opening 130 with triple pins 61 being inserted through the holes of the insulative housing 1, the through holes 22 of the printed circuit board 2. The ribs 62 of the pins 61 abut against the inner surfaces of the holes for providing an interference fit and ensuring a reliable connection between the insulative housing 1 and the pin member 6.

Then the latch member 5 is assembled to the upper wall 12 of the insulative housing and the cover 4, the retaining portion 51 is engaged with the mounting portion 121 of the body portion 10 to make the latch member 5 positioned on the insualtive housing 1. The locking portion 52, the pressing portion 53, the inclined supporting portion 54, and the inclined intermediate portion 55 are cantilevered relative to the retaining portion 51 and disposed at upside of the protrusion 401. The pair of spring tabs 531 of the pressing portion 53 are respectively located below the ear portions 402 of the cover 4 for preventing the latch member 5 excessive rebound when the operator withdraw a downward force exerted on the pressing portion 53. Thus, the cable connector assembly 100 is assembled. As the cover 4 is over-molded on the printed circuit board 2 and the flat cable 3, it's no need to tear the flat cable 3, and the manufacture cost can be lower. The cover 4 and the insulative housing 1 together form an L-shaped configuration, thus the cable 3 is extending along the direction perpendicular to the mating direction, the cable connector assembly 100 can have a smaller dimension.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A cable connector assembly, comprising:
an insulative housing having a body portion with a receiving slot and a pair of tongue sections opposite to each other and respectively extending forwardly from a front surface of the body portion;
a printed circuit board received in the insulative housing;
a cable electrically connected with the printed circuit board; and
an insulative cover assembled to the insulative housing;
wherein the printed circuit board is extending along a mating direction, and the cable is extending along a direction perpendicular to the mating direction, the cover is over-molded on the cable and the printed circuit board, and engaging with the insulative housing.

2. The cable connector assembly as claimed in claim 1, wherein the cable is flat, and a central plane of the cable is coplanar to a center surface of the insulative housing and the insulative cover.

3. The cable connector assembly as claimed in claim 1, wherein the cover comprises a main portion and a projecting portion forwardly extending from a front surface of the main portion.

4. The cable connector assembly as claimed in claim 3, wherein the main portion is extending along the direction perpendicular to the mating direction.

5. The cable connector assembly as claimed in claim 3, wherein the projecting portion defines a rectangular primary portion and a pair of engaging portions on both sides of the primary portion, the insulative housing defines a pair of cutouts receiving the corresponding engaging portions.

6. The cable connector assembly as claimed in claim 3, wherein the printed circuit board defines a mating portion and a rear portion, and the mating portion is extending through the receiving slot of the insulative housing and exposed between the pair of tongue sections.

7. The cable connector assembly as claimed in claim 3, wherein the cable connector assembly further comprises a latch member assembled on the insulative housing and the cover, and the latch member comprises a retaining portion, a pair of locking portions extending upwardly and rearwardly from the retaining portion, a pressing portion formed at a rear position of the pair of locking portions, an inclined supporting portion slantwise extending from the pressing portion, and an intermediate portion connecting the pressing portion with the locking portions.

8. The cable connector assembly as claimed in claim 7, wherein the main portion defines a protrusion extending upwards from a top surface thereof and a pair of ear portions on both sides of the protrusion, the locking portion, the pressing portion, the inclined supporting portion, and the intermediate portion are cantilevered relative to the retaining portion and disposed at upside of the protrusion.

9. The cable connector assembly as claimed in claim 8, wherein the pressing portion defines a pair of spring tab disposed at two sides thereof, and the spring tabs are respectively located below the ear portions of the cover, the retaining portion is engaged with the mounting portion of the body portion.

10. The cable connector assembly as claimed in claim 1, further comprising a pin member, the cover is over-molded on the cable and the printed circuit board, and assembled to the insulative housing along the mating direction.

11. The cable connector assembly as claimed in claim 10, wherein a depressed opening is defined on a lower wall of the insulative housing, a plurality of through holes are disposed on the printed circuit board, the pin member is inserted into the depressed opening and the through holes to fasten the printed circuit board with the insulative housing.

12. A cable connector assembly comprising:
a housing including a mating port defining a long side extending a vertical direction, and a short side extending in a transverse direction perpendicular to said vertical direction, said mating port communicating with an exterior in a front-to-back direction perpendicular to both said vertical direction and said transverse direction;
a printed circuit board extending in a vertical plane defined by said vertical direction and said front-to-back direction, said printed circuit board having a front section assembled to the housing and exposed in the mating port, and a rear section enclosed in an insulative cover which is assembled to and located behind the housing; and
a cable connected to the rear section of the printed circuit board and extending out of the insulative cover in the vertical direction.

13. The cable connector assembly as claimed in claim 12, wherein the insulative cover defines an L-shaped configuration with a length longer than that of the housing in the vertical direction.

14. The cable connector assembly as claimed in claim 13, further including a latch located on a side with a front locking portion around the housing and a rear operation portion around the cover, wherein said latch is moveable in the transverse direction.

15. The cable connector assembly as claimed in claim 12, wherein the rear section of the printed circuit board defines a plurality of conductive pads arranged in at least one row in the vertical direction for connecting to the cable.

16. A cable connector assembly comprising:
a housing including a mating port defining a long side extending a vertical direction, and a short side extending in a transverse direction perpendicular to said vertical direction, said mating port communicating with an exterior in a front-to-back direction perpendicular to both said vertical direction and said transverse direction;
a printed circuit board extending in a vertical plane defined by said vertical direction and said front-to-back direction, said printed circuit board having a front section assembled to the housing and a rear section enclosed in an insulative cover which is assembled to and located behind the housing;
a cable connected to the rear section of the printed circuit board and extending out of the insulative cover in the vertical direction; and
a latch located on a side with a front locking portion around the housing and a rear operation portion around the cover, wherein said latch is moveable in the transverse direction.

17. The cable connector assembly as claimed in claim 16, wherein the front section of the printed circuit board defines a plurality of conductive pads arranged in at least one row and exposed in the mating port.

18. The cable connector assembly as claimed in claim 17, wherein the insulative cover defines an L-shaped configuration with a length longer than that of the housing in the vertical direction.
